(19) United States
(12) Patent Application Publication
(10) Pub. No.: US 2008/0014877 A1
(43) Pub. Date: Jan. 17, 2008

(54) Carrier frequency shifting in mobile communications

(75) Inventors: Jari Hulkkonen, Oulu (FI); Kari Niemela, Oulu (FI); Olli Piirainen, Oulu (FI); Mikko Saily, Sipoo (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/726,734

(22) Filed: Mar. 22, 2007

Related U.S. Application Data
(60) Provisional application No. 60/793,396, filed on Apr. 19, 2006.

(51) Int. Cl. H04B 1/02

(52) U.S. Cl. 455/114.2

(57) ABSTRACT

The specification and drawings present a new method, system, apparatus and software product for carrier frequency shifting in mobile communication systems, e.g., for eliminating or reducing interference, e.g., for a communication between a mobile station and a network element. The communication between the mobile station and the network element may be performed within a GSM/EDGE radio access network. A signal (e.g., a DSR or MDSR carrier) and at least one further signal (e.g., a speech carrier) are identified, wherein bandwidths of the signal and of the at least one further signal overlap. Then, a frequency shift for said signal may be determined according to a predetermined criterion and a carrier frequency of the signal may be shifted by the determined frequency shift, e.g., for eliminating or reducing the interference.

### CROSS-REFERENCE TO RELATED APPLICATION

This application claims priority from U.S. Patent Application Ser. No. 60/793,396, filed on Apr. 19, 2006.

### TECHNICAL FIELD

This invention generally relates to mobile communications and more specifically to carrier frequency shifting in mobile communication systems, e.g., for eliminating or reducing interference.

### BACKGROUND ART

Further evolution of EDGE (enhanced data rates for global evolution) continues in 3GPP(3d generation partnership project) Release 7 known as Evolved GERAN (GSM (global system for mobile communications)/EDGE) radio access network) 3GPP. Dual Symbol Rate (DSR) for uplink performance improvement is proposed as shown in 3GPP contributions, e.g., in GP-05261, Agenda Item 7.1.5.5, “Updates for Dual Symbol Rate Section of the Feasibility Study on Future GERAN Evolution”, 3GPP TSG GERAN#27, Atlanta, USA. In the DSR, the symbol rate of the GSM/EDGE is doubled and the transmitter signal is allowed to overlap adjacent carriers. The DSR nearly doubles UL (uplink) data spectral efficiency and is, therefore, the interesting UL capacity enhancement feature for the EDGE evolution. From the system performance point of view, frequency planning needs to be considered carefully because adjacent DSR carriers are partially overlapping, which brakes the basic frequency planning that is made for the normal 200 kHz carriers because the DSR carriers have a spectrum of approximately 600 kHz wide (a 3 dB bandwidth of 541 kHz) compared to the normal 200 kHz wide carriers as shown in FIG. 1. In the DSR concept the symbol rate was doubled, thus doubling the bit rate over the air interface can be obtained with the same modulation. This makes it possible to use the current EGPRS (enhanced general packet radio service) coding schemes for the DSR, only transmit them with the double bit rate.

Also in the case of EGPRS, interference conditions need to be considered when data connections are allocated to the hopping layer. Data connections are typically causing more interference than speech connections (e.g., because data uses higher transmitter powers since C/I (carrier-to-interference ratio) and the target is higher compared to AMR/FS (adaptive multi-rate full rate speech).

As shown in FIG. 1, the DSR carrier overlaps with adjacent carriers so that the interference situation is worse in the network using DSR; then the original frequency reuse is blurred in the DSR case. As adjacent DSR carriers are overlapping, usage of DSR makes the interference situation uncontrolled when basic frequency planning is used.

Moreover, in the case of the EGPRS, increased interference from data connections can be a problem, data traffic is allocated to hopping layer which was originally planned for the speech traffic only. Increased interference decreases speech traffic performance.

In the GSM system, co-channel and adjacent channel interference is controlled with the frequency planning. Data and speech traffic can be separated for different frequencies so that speech and data are not interfering with each other. Data traffic can be allocated to BCCH (broadcast control channel) frequencies as far as there are enough resources in a BCCH TRX (transceiver). But, when the BCCH TRX capacity is not enough for the data transmission, a certain amount of hopping layer resources need to be reserved for data. In that case, speech and data connections are interfering with each other. The EGPRS power control is one way to control the interference caused by the data traffic, but then the trade-off between the data throughput and the speech quality is made.

For the DSR concept proposed for the EDGE evolution in 3GPP there are no specific solutions available to control interference caused by wider DSR carriers. As stated in the DSR feasibility study (see GP-052610 quoted above), the current solution is to use IRC (interference rejection combining) receivers and try to cope with increased interference in the network. Also, advanced channel allocation methods which allocate channels based on interference conditions could be used, like proposed in the invention “Radio channel allocation and link adaptation in cellular telecommunication system” by Jari Hulkkonen and Olli Piirainen, filed as a Finnish patent application No. 20055687 on Dec. 21, 2005, but those require more complex allocation algorithms, interference evaluation, etc.

A new uplink (UL) concept, called Modified DSR (MDSR), is described and claimed in co-pending, co-owned application (Att. Doc. No 944-008.036) filed on even date herewith. The modified dual symbol rate (MDSR ) can be one and a half times a symbol rate of an uplink speech service, e.g., the current GSM/EDGE symbol rate ( 13/48 MHz) in the mobile communication system, thus the modified dual symbol rate is substantially 13/32 MHz with a 3 dB (half power) bandwidth of about 405 kHz. The uplink signal with the MDSR may be modulated using a quadrature amplitude modulation (QAM), e.g., 16-QAM with 16 states and optionally a quadrature phase-shift keying (QPSK, or π/4-QPSK) modulation.

Moreover, the uplink signal utilizing the MDSR may be modulated using the quadrature amplitude modulation (e.g., 16-QAM) having a bit rate substantially equal to two times of a peak bit rate of the uplink EGPRS service, i.e., having the same peak bit rate as provided in case of the DSR. Variable coding rates may be provided by several MCSs (modulation and coding schemes).

Furthermore, the uplink signal utilizing the MDSR may be optionally modulated using the quadrature phase-shift keying (QPSK) modulation having a peak bit rate substantially equal to the bit rate of the uplink EGPRS service.

Both DSR and MDSR carriers overlap with adjacent carriers. DSR carrier overlapping with EDGE carriers is shown in FIG. 1. Note that even though MDSR spectrum is only about 400 kHz, it still can overlap with 3 carriers. DSR/MDSR carrier overlapping can blur original GSM/EDGE frequency planning and can make an interference situation uncontrolled. This degrades the system performance especially for legacy (non DSR or MDSR) services, e.g. circuit switched speech.

Moreover, the DSR and MDSR may need a wider channel filter than exists in a typical BSS (base station subsystem) and also it may not be possible to tune receiving frequencies out of normal 200 kHz channel raster. Also, by using separate frequency bands (including a guard band), a DSR/MDSR interference can be isolated from the legacy services. However, spectrum splitting requires large bandwidth and wastes resources.

### DISCLOSURE OF THE INVENTION

According to a first aspect of the invention, a method, comprises: identifying a signal and at least one further signal in a service based mobile communication system, wherein bandwidths in a frequency domain of the signal and of the at least one further signal overlap; and determining a frequency shift for shifting a carrier frequency of the signal according to a predetermined criterion.

According further to the first aspect of the invention, the determining the frequency shift for the signal according to the predetermined criterion may be performed using at least one of: a bandwidth of the signal, a bandwidth of the at least one further signal, the carrier frequency of the signal, and a degree of the overlap of the bandwidths.

Further according to the first aspect of the invention, the determining the frequency shift for the signal according to the predetermined criterion may comprise: identifying that the signal is interfering with the at least one further signal according to a predetermined rule, and selecting the frequency shifting, if the overlapping of the bandwidths of the interfering signals is larger than a pre-selected amount.

Still further according to the first aspect of the invention, the frequency shift may be a fixed offset.

According yet further to the first aspect of the invention, the signal may have a dual symbol rate of 13/24 MHz with the bandwidth at half power substantially equals 541 kHz, the signal may have a modified dual symbol rate of 13/32 MHz with the bandwidth at half power substantially equals 405 kHz, or the signal may have a rate of 13/48 or 13/40 MHz with the bandwidth at half power substantially equals 325 kHz.

According still further to the first aspect of the invention, the frequency shift may be at least one of: plus or minus 200 kHz, and plus or minus 100 kHz.

According further still to the first aspect of the invention, the signal and the at least one further signal may be for a communication between a mobile station and a network element in the mobile communication system. Further, the signal and the at least one further signal may be for an uplink communication from a mobile station to a network element. Still further, the communication between the mobile station and the network element may be performed within an evolved global system for mobile communications/enhanced data rates for global evolution radio access network. Yet still further, the identifying or the determining may be performed by at least one of: the network element, and the mobile station. Still yet further, the identifying and the determining may be performed by the network element and the signal may be received by the network element from the mobile station, and the method may further comprise: providing an instruction signal comprising the frequency shift by the network element to the mobile station for shifting the carrier frequency of the signal. Yet further still, the identifying and the determining may be performed by the mobile station and the signal may be provided by the mobile station to the network element, and the method may further comprise: shifting by the mobile station a carrier frequency of the signal by the frequency shift.

According yet further still to the first aspect of the invention, the at least one further signal may be at least one out of: a speech signal, a data signal using an enhanced general packet radio service, and a data signal using a dual symbol rate or a modified dual symbol rate.

Yet still further according to the first aspect of the invention, the service based mobile communication system may be configured to be for at least one of the following services: a dual symbol rate service, a modified symbol rate service, and an enhanced general packet radio service.

Still yet further according to the first aspect of the invention, the shifting the carrier frequency may be for avoiding or minimizing overlapping of the bandwidths.

According to a second aspect of the invention, a computer program product comprises: a computer readable storage structure embodying computer program code thereon for execution by a computer processor with the computer program code, wherein the computer program code comprises instructions for performing the first aspect of the invention, indicated as being performed by any component or a combination of components of the mobile communication system.

According to a third aspect of the invention, a method, comprises: generating an uplink signal by a mobile station of a mobile communication system, wherein a carrier frequency of the signal is shifted by a frequency shift; and transmitting the signal by the mobile station to a network element, wherein the signal and at least one further signal in the mobile communication system are identified, wherein bandwidths in a frequency domain of the signal and of the at least one further signal overlap before shifting said carrier frequency of the signal by the frequency shift, and the frequency shift is determined using a predetermined criterion.

Still yet further according to the third aspect of the invention, the network element may be a base transceiver station, and the mobile station may be a wireless communication device, a portable device, a mobile communication device, a mobile phone or a mobile camera phone.

According to a fourth aspect of the invention, a mobile communication system, comprises: a frequency shift determining block configured to identify a signal and at least one further signal in the mobile communication system, wherein bandwidths in a frequency domain of the signal and of the at least one further signal overlap, and further to determine a frequency shift for the signal according to a predetermined criterion; a signal generating block configured to shift a carrier frequency of the signal by the frequency shift; a transmitter configured to transmit the signal with the frequency shift; and a receiver configured to receive the signal with the frequency shift.

According further to the fourth aspect of the invention, a network element of the mobile communication system may comprise the frequency shift determining block and the receiver, and a mobile station of mobile communication system may comprise the signal generating block and the transmitter.

According to a fifth aspect of the invention, a mobile station of a mobile communication system, comprises: an uplink scheduling and signal generating module configured to generate an uplink signal, wherein a carrier frequency of the signal is shifted by a frequency shift; and a module configured to transmit the signal to a network element, wherein the signal and at least one further signal in the mobile communication system are identified, wherein bandwidths in a frequency domain of the signal and of the at least one further signal overlap before shifting said carrier frequency of the signal by the frequency shift, and the frequency shift is determined using a predetermined criterion.

According further to the fifth aspect of the invention, the uplink scheduling and signal generating module may be further configured to determine the frequency shift for the signal according to the predetermined criterion using at least one of: a bandwidth of the signal, a bandwidth of the at least one further signal, the carrier frequency of the signal, and a degree of the overlap of the bandwidths.

Further according to the fifth aspect of the invention, the uplink scheduling and signal generating module may be further configured to determine the frequency shift for the signal according to the predetermined criterion by: identifying that the signal is interfering with the at least one further signal according to a predetermined rule, and selecting the frequency shifting, if the overlapping of the bandwidths of the interfering signals is larger than a pre-selected amount.

Still further according to the fifth aspect of the invention, the frequency shift may be a fixed offset.

According further to the fifth aspect of the invention, the signal may have a dual symbol rate of 13/24 MHz with the bandwidth at half power substantially equals 541 kHz, the signal may have a modified dual symbol rate of 13/32 MHz with the bandwidth at half power substantially equals 405 kHz, or the signal may have a rate of 13/48 or 13/40 MHz with the bandwidth at half power substantially equals 325 kHz.

According still further to the fifth aspect of the invention, the frequency shift may be at least one of: plus or minus 200 kHz, and plus or minus 100 kHz.

According further still to fifth aspect of the invention, the at least one further signal may be at least one out of: a speech signal, a data signal using an enhanced general packet radio service, and a data signal using a dual symbol rate or a modified dual symbol rate.

According to a sixth aspect of the invention, a network element of a mobile communication system, comprises: a frequency shift determining and scheduling block configured to identify a signal and at least one further signal in the mobile communication system, wherein bandwidths in a frequency domain of the signal and of the at least one further signal overlap, and further configured to determine a frequency shift of the signal using a predetermined criterion, and still further configured to provide an instruction to a mobile station to shift a carrier frequency of the signal by the frequency shift; and a receiver configured to receive the signal with the frequency shift from the mobile station.

According further to the sixth aspect of the invention, the frequency shift determining and scheduling block may be configured to determine the frequency shift for the signal according to the predetermined criterion using at least one of: a bandwidth of the signal, a bandwidth of the at least one further signal, the carrier frequency of the signal, and a degree of the overlap of the bandwidths.

Further according to the sixth aspect of the invention, the frequency shift determining and scheduling block may be configured to determine the frequency shift for the signal according to the predetermined criterion by: identifying that the signal is interfering with the at least one further signal according to a predetermined rule, and selecting the frequency shifting, if the overlapping of the bandwidths of the interfering signals is larger than a pre-selected amount.

Still further according to the sixth aspect of the invention, the signal may have a dual symbol rate of 13/24 MHz with the bandwidth at half power substantially equals 541 kHz, the signal may have a modified dual symbol rate of 13/32 MHz with the bandwidth at half power substantially equals 405 kHz, or the signal may have a rate of 13/48 or 13/40 MHz with the bandwidth at half power substantially equals 325 kHz.

According further to the sixth aspect of the invention, the frequency shift may be at least one of: plus or minus 200 kHz, and plus or minus 100 kHz.

According still further to the sixth aspect of the invention, the at least one further signal may be at least one out of: a speech signal, a data signal using an enhanced general packet radio service, and a data signal using a dual symbol rate or a modified dual symbol rate.

### BRIEF DESCRIPTION OF THE DRAWINGS

For a better understanding of the nature and objects of the present invention, reference is made to the following detailed description taken in conjunction with the following drawings, in which:

FIG. 1 is a schematic representation of a spectrum of dual symbol rate (DSR) compared to basic GSM/EDGE spectrum;

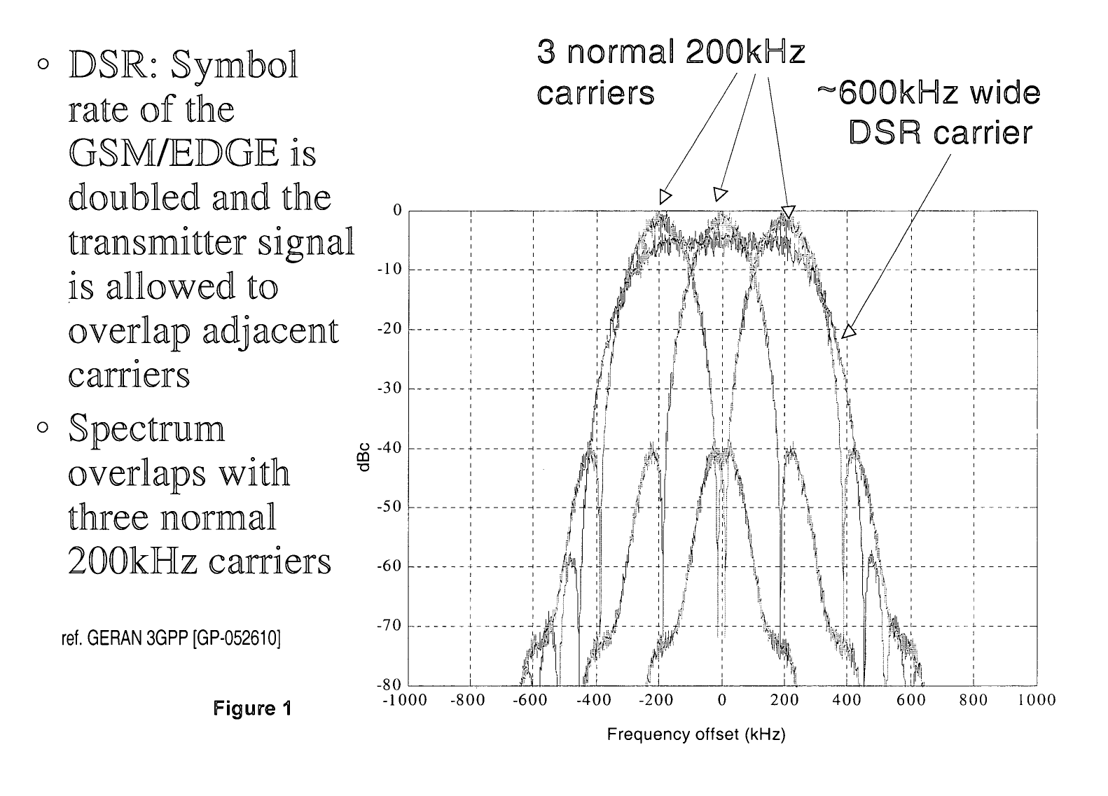

FIGS. 2a through 2c are schematic representations demonstrating DSR carrier frequency shifting with a ⅓ frequency reuse for 12 carrier frequencies: a) carrier frequencies before a DSR frequency shift; b) carrier frequencies after the DSR frequency shift; and c) interfering cells for a ⅓ frequency reuse of 12 frequencies and 4 transceivers per cell, according to an embodiment of the present invention;

FIGS. 3a through 3c are schematic representations demonstrating MDSR carrier frequency shifting with a ⅓ frequency reuse for 12 carrier frequencies: a) carrier frequencies before an MDSR frequency shift; b) carrier frequencies after the MDSR frequency shift (+100 kHz); and c) interfering cells for a ⅓ frequency reuse of 12 frequencies and 4 transceivers per cell, according to an embodiment of the present invention;

FIGS. 4a through 4c are further schematic representations demonstrating MDSR carrier frequency shifting with a ⅓ frequency reuse for 12 carrier frequencies: a) carrier frequencies before an MDSR frequency shift; b) carrier frequencies after the MDSR frequency shift (+100 kHz); and c) interfering cells for a ⅓ frequency reuse of 12 frequencies and 4 transceivers per cell, according to an embodiment of the present invention;

FIG. 5 is a block diagram of a mobile communication system with carrier frequency shifting for eliminating or reducing interference, according to an embodiment of the present invention;

FIG. 6 is a flow chart for implementing carrier frequency shifting in a mobile communication system, according to an embodiment of the present invention.

FIG. 7 is a flow chart for implementing carrier frequency shifting in a mobile communication system for eliminating or reducing interference, according to an embodiment of the present invention.

### MODES FOR CARRYING OUT THE INVENTION

A new method, system, apparatus and software product are presented for carrier frequency shifting in mobile communication systems, e.g., for eliminating or reducing interference, e.g., for a communication between a mobile station and a network element. The communication between the mobile station (MS) and the network element may be performed within an evolved global system for mobile communications/enhanced data rates for global evolution (GSM/EDGE) radio access network. The network element may be, e.g., a base transceiver station (BTS). The mobile station may be (but is not limited to): a mobile phone, a wireless device, a mobile camera phone, etc. The frequency shifting can be applied to the signals in an uplink (UP) direction (e.g., from the mobile station to the network element) as well as in a downlink (DL) direction.

According to an embodiment of the present invention, a signal (e.g., a DSR or MDSR packet switched data carrier) and at least one further signal (e.g., a circuit switch speech carrier, a data signal using EGPRS, and/or another DSR or MDSR carrier) in the mobile communication system are identified, wherein bandwidths in a frequency domain of the signal and of the at least one further signal overlap. Then, a frequency shift for said signal may be determined according to a predetermined criterion, and a carrier frequency of the signal may be shifted by the determined frequency shift. The determining the frequency shift according to the predetermined criterion may be performed using at least one of the following parameters: a bandwidth of the signal, a bandwidth of the at least one further signal, the carrier frequency of the signal, a degree of the bandwidth overlap. It is further noted that the signal described herein can also have various symbol rates including rates different than in the EGPRS (having symbol rate of 13/48 MHz with the bandwidth at half power substantially equals 180 kHz) such as a dual symbol rate of 13/24 MHz with the bandwidth at half power substantially equals 541 kHz, a modified dual symbol rate of 13/32 MHz with the bandwidth at half power substantially equals 405 kHz, a symbol rate of 13/48 or 13/40 MHz with the bandwidth at half power substantially equals 325 kHz for a Higher Uplink performance for GERAN Evolution (HUGE), etc.

Moreover, the determining the frequency shift for the signal according to the predetermined criterion may comprise of: a) identifying that the signal interfering with the at least one further signal according to a predetermined rule, and b) selecting the frequency shifting, if the overlapping of the bandwidths of said interfering signals is larger than a pre-selected amount for eliminating or reducing the interference. The predetermined rule can be, for example, overlapping in excess of a pre-selected amount, e.g., of 100 kHz, 50%, etc. Then if the overlapping of said bandwidths is larger than the pre-selected amount, the carrier frequency of the signal is shifted by a frequency shift using a predetermined criterion for eliminating or reducing the interference. The frequency shift can be implemented “statically” (wherein the frequency shift, e.g., is a fixed offset), i.e., for a duration of a communication session such as a phone conversation or transmission of an SMS (short message service) message or duration of an uplink TBF (temporary block flow), or dynamically, i.e., changing the frequency shift during the communication session based on the interference conditions.

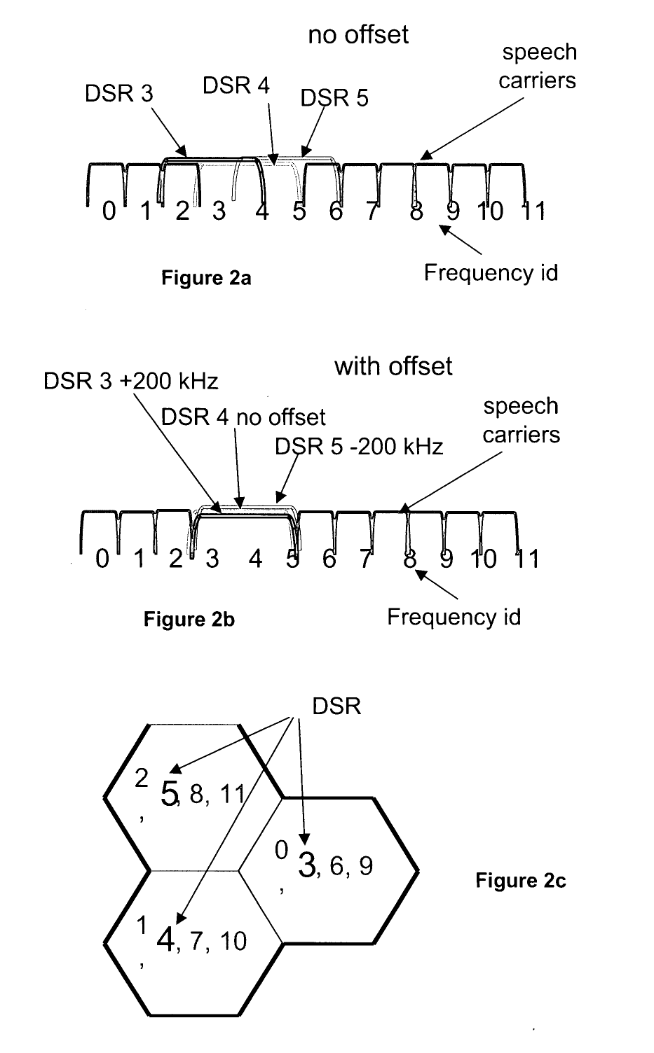

FIGS. 2a through 2c show an example among others of schematic representations demonstrating DSR (dual symbol rate) carrier frequency shifting with a ⅓ frequency reuse for 12 carrier frequencies, wherein FIG. 2a shows carrier frequencies before the DSR frequency shift, FIG. 2b shows carrier frequencies after the DSR frequency shift; and FIG. 2c shows interfering cells for the ⅓ frequency reuse of 12 frequencies and 4 transceivers per cell, according to an embodiment of the present invention. Numbers 0, 2 . . . , and 11 in FIGS. 2a-2c indicate frequencies identifications (IDs) of 12 frequencies. Frequencies 3, 4 and 5 are DSR frequencies and the rest of the frequencies (0-2, 6-11) are speech carrier frequencies.

FIG. 2a shows that the DSR carrier frequencies (or DSR carriers) 3 and 5 overlap with frequencies 2 and 6 that are used for speech. However, when the DSR carrier 3 is shifted by +200 kHz and the DSR carrier 5 is shifted by −200 kHz, as shown in FIG. 2b, then all DSR carriers are fully overlapping, but there is no overlapping the DSR carriers to the speech service (and vice versa). Thus, interference between the DSR and legacy services can be totally avoided between the adjacent sectors. From the DSR performance point of view, there is no significant difference if the interferer is located ±200 kHz from or exactly in the same frequency, because DSR carriers separated with ±200 kHz are still overlapping more than 50%, i.e., the frequency reuse between DSR carriers is one in any case (from the interference point of view).

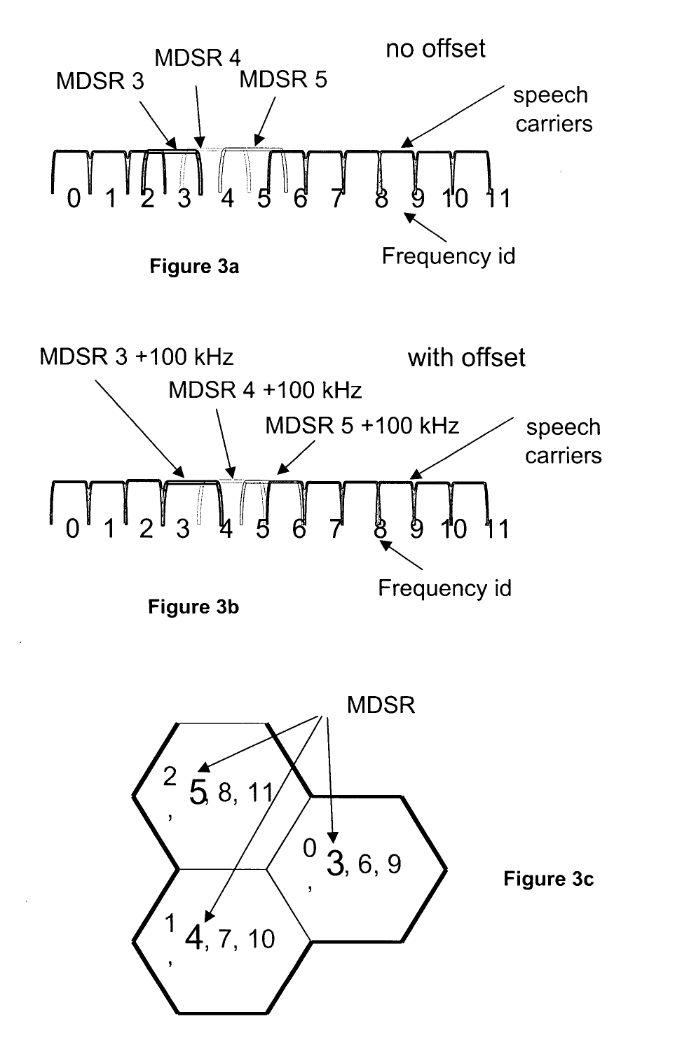

FIGS. 3a through 3c show an example among others of schematic representations demonstrating MDSR (modified dual symbol rate) carrier frequency shifting with the ⅓ frequency reuse for 12 carrier frequencies, wherein FIG. 2a shows carrier frequencies before the MDSR frequency shift, FIG. 2b shows carrier frequencies after the MDSR frequency shift; and FIG. 2c shows interfering cells for the ⅓ frequency reuse of 12 frequencies and 4 transceivers per cell, according to a further embodiment of the present invention. Numbers 0, 2 . . . , and 11 in FIGS. 3a-3c indicate frequencies identifications (IDs) of 12 frequencies. Frequencies 3, 4 and 5 are MDSR frequencies and the rest of the frequencies (0-2, 6-11) are speech carrier frequencies.

FIG. 3a shows that the MDSR carrier frequencies (or MDSR carriers) 3 and 5 overlap with frequencies 2 and 6, respectively, that are used for speech. However, when each of the MDSR carriers 3, 4 and 5 is shifted by a fixed offset +100 kHz (alternatively the MDSR carrier 4 can be shifted by −100 kHz) as shown in FIG. 3b, then the MDSR carriers 3 and 4 are not overlapping with the speech service (and vice versa) and only the MDSR carrier 5 still overlaps with the speech carrier 6. Also the MDSR carriers 3 and 5 do not overlap with each other and the MDSR carriers 4 insignificantly overlaps with the MDSR carriers 3 and 5 such that the frequency reuse may be still possibly used with carriers 3, 4 and 5. Thus, interference between the DSR and legacy services can be significantly reduced between the adjacent sectors.

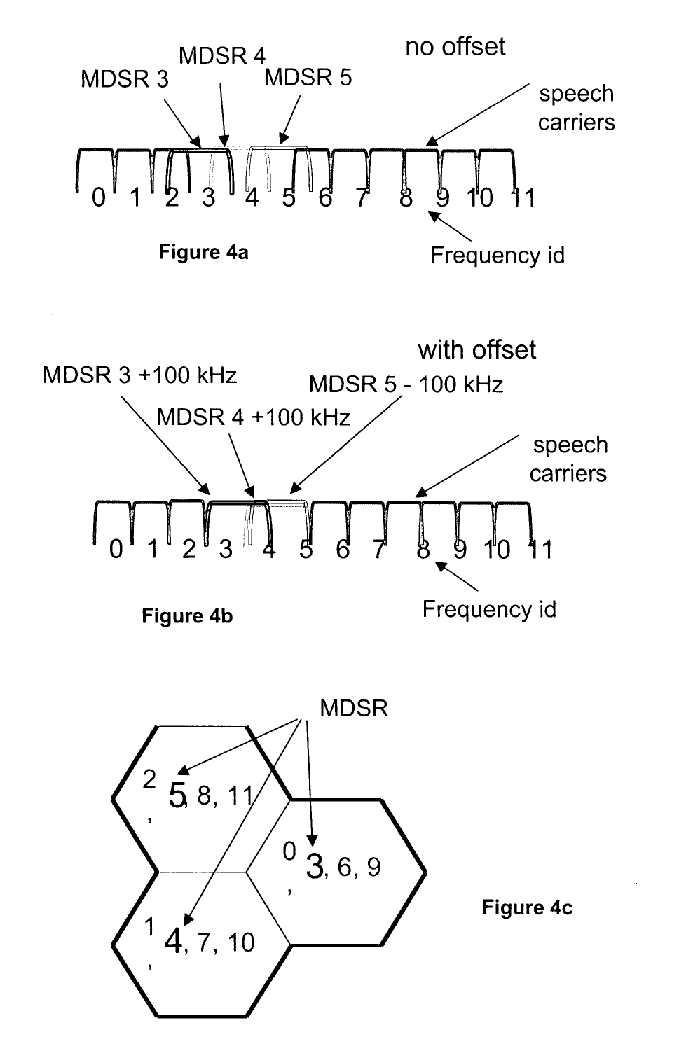

FIGS. 4a-4c are similar examples of the MDSR frequency shifting as shown in FIGS. 3a-3c, with the only difference that the carrier 5 in FIG. 4b is shifted by −100 kHz, thus there is no overlapping between the MDSR carrier 5 and the speech carrier 6 and therefore no overlapping between the MDSR and speech carriers (and vice versa).

In case of the MDSR frequency shifting of ±100 kHz, the effect of reducing or eliminating interference may be even more effective than the DSR frequency shifting as shown in FIG. 2b, because in the MDSR case the number of overlapping carriers decreases to 2, as shown in FIG. 3b (e.g., overlapping carriers 5 and 6) and in FIG. 4b (e.g., overlapping carriers 4 and 5).

Moreover, in case of the MDSR frequency shifting, it can be chosen whether the carrier is shifted −100 or +100 kHz. This selection of the appropriate frequency shift can be done based on mobile station and/or network measurements. For example, if a mobile station configured for providing the MDSR service receives a strong BCCH signal from a neighboring cell, it potentially interferes with that cell in the uplink. Therefore, based on the frequency planning parameters, the frequency shifting can be done so that the interference towards the potentially highly interfered cell is avoided or significantly reduced. It is noted that examples presented in FIGS. 2a-2c, 3a-3c and 4a-4c for the frequency reuse of ⅓ are also applicable for other frequency reuse values and/or time reuse, especially in case of 3-sectorized base stations.

A performance of the frequency shifting has been studied with system and link simulations. Traffic model was mixed: packet data traffic 20% and AMR (adaptive multi rate) speech traffic 80%. The MDSR was used first without carrier frequency shifting and then with fixed +100 kHz offset. The AMR speech service performance was measured and it was noted that performance was clearly improved. Number of bad AMR speech quality calls was 1.3% without the frequency shift (offset) and 1.05% with the fixed +100 kHz offset. Then, MDSR results show at least one dB gain for the MDSR data performance for +100 kHz offset. It is expected that by selecting plus or minus 100 kHz offset based on the interference conditions (using, e.g., network plan and/or MS measurements) would further improve the system performance.

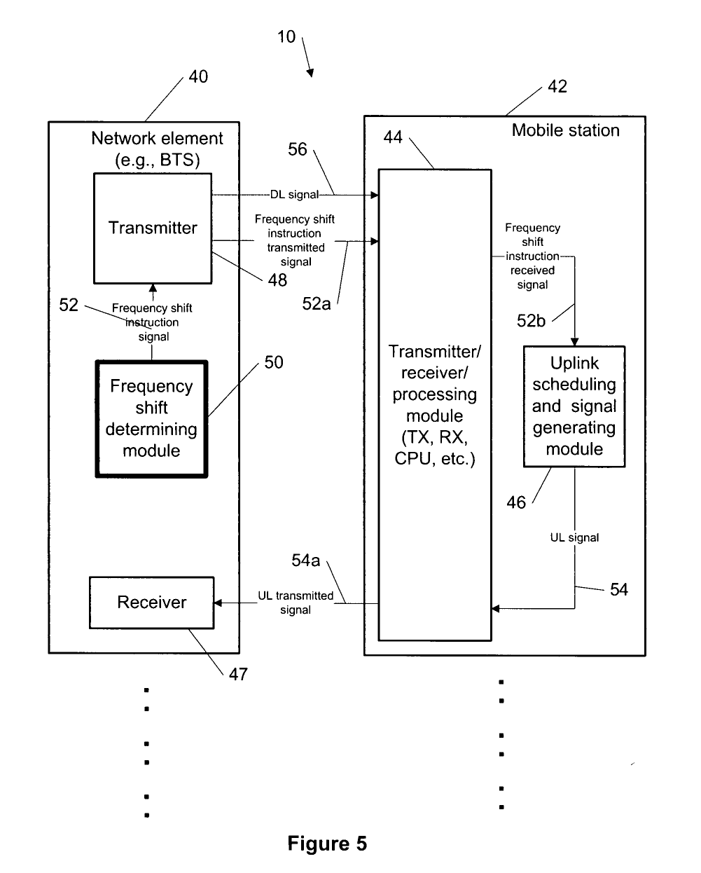

FIG. 5 is an example among others of a block diagram of a mobile communication system 10 with the carrier frequency shifting (e.g., using DSR or MDSR signals) for eliminating or reducing interference, according to an embodiment of the present invention; and

In the example of FIG. 5, the mobile station (or user equipment) 42 comprises an uplink scheduling and signal generating module 46 and a transmitter/receiver/processing module 44. In the context of the present invention, the mobile station 42 can be a wireless communication device, a portable device, a mobile communication device, a mobile phone, a mobile camera phone, etc. In the example of FIG. 5, a network element 40 (e.g., a BTS or a Node B) can comprise a transmitter 48, a frequency shift determining and scheduling module 50 and a receiver 47. It is noted that the module 46 can generally be means for signal generation or a structural equivalence (or equivalent structure) thereof. Also, the module 44 can generally be transmitting and/or receiving means, e.g., a transceiver, or a structural equivalence (or equivalent structure) thereof. Moreover, the receiver 47 can generally be means for receiving the uplink signal, e.g., a transceiver, or a structural equivalence (or equivalent structure) thereof. Furthermore, the module 50 can generally be means for identifying signals and for determining frequency shifts, or a structural equivalence (or equivalent structure) thereof.

According to an embodiment of the present invention, the network, e.g., the module 50 of the network element 50 (or it can be another network element), may provide a frequency shift instructions (i.e., signal 52). In case of the downlink (DL), these instructions may be provided to the module 48 which will generate and send a DL signal 56 (e.g., comprising data and/or voice information) with the appropriate frequency shift to the mobile station 42. The uplink (UL) frequency shift instructions (e.g., for the DSR and/or MDSR frequency carriers) contained in the signal 52 are forwarded (signal 52a) to the module 44 of the mobile station 42 and then further forwarded (signal 52b) to the module 46. The module 46 can use the uplink frequency shift instructions contained in the signal 52b for generating an UL signal 54 (e.g., comprising data and/or voice information), which is forwarded by the module 44 (signal 54a) to the receiver 47 of the network element 40. Alternatively, the module 46 (instead or in addition to the module 50) can be used for determining the frequency shift according to the predetermined criterion. The determination whether the frequency shift is needed based on the interference conditions may be performed by the module 50 consequently providing the instruction signal 52 to the mobile station 42. Alternatively or in addition, this determination whether the frequency shift is needed for the uplink may be performed by the mobile station 42 (e.g., by the module 46) based on the interference signals received by the mobile station 42 from the neighboring cells.

According to an embodiment of the present invention, the module 44, 46, 47, 48 or 50 can be implemented as a software block, a hardware block or a combination thereof. Furthermore, each of the modules 44, 46, 47, 48 or 50 can be implemented as a separate module or can be combined with any other standard block of the mobile station 42 or the network element 40, or it can be split into several blocks according to their functionality. The transmitter/receiver/processing block 44 can be implemented in a plurality of ways and typically can include a transmitter, a receiver, a CPU (central processing unit), etc. The transmitter and receiver can be combined, for example, in one module such as transceiver, as known in the art. The module 44 provides an effective communication of the module 46 with the network element 40.

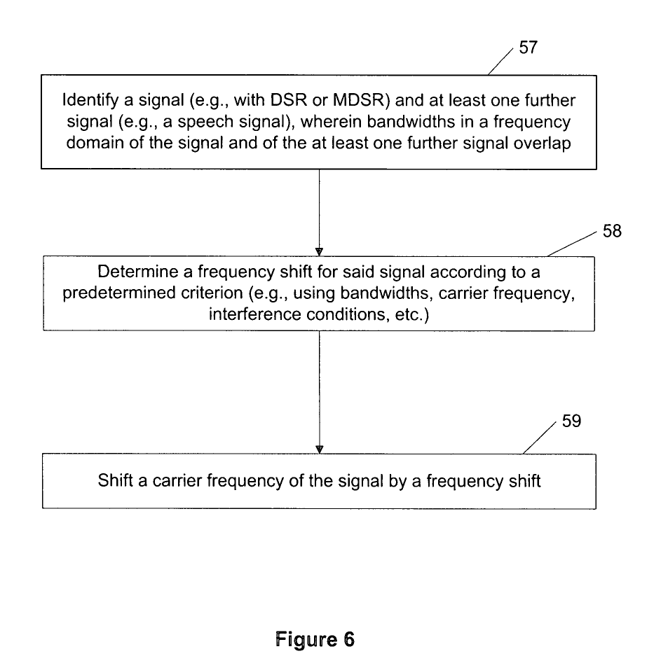

FIG. 6 is a flow chart for implementing carrier frequency shifting in a mobile communication system for eliminating or reducing interference, according to an embodiment of the present invention.

The flow chart of FIG. 6 only represents one possible scenario among others. The order of steps shown in FIG. 6 is not absolutely required, so generally, the various steps can be performed out of order. In a method according to the first embodiment of the present invention, in a first step 57, a signal (e.g., with DSR or MDSR) and at least one further signal are identified by the network (e.g., a network element such as BTS, BSS or Node B, etc.) and/or by the mobile station, wherein the bandwidths in a frequency domain of the signal and of the at least one further signal overlap.

In a next step 58, a frequency shift for that signal is determined according to a predetermined criterion (e.g., using bandwidths, carrier frequency, interference conditions, etc.) and in a next step 59, the carrier frequency of the signal is shifted by a frequency shift, e.g., for eliminating or reducing the interference.

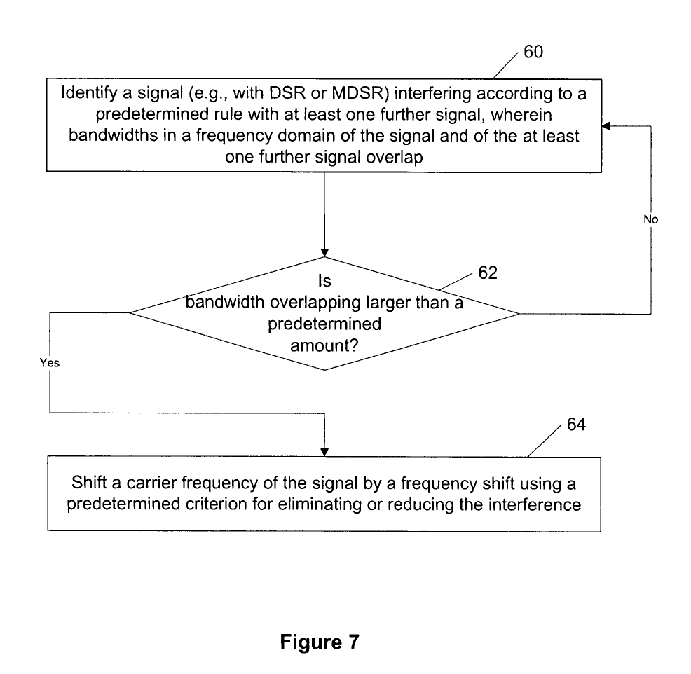

FIG. 7 is a flow chart for implementing carrier frequency shifting in a mobile communication system specifically for dynamically eliminating or reducing interference, according to an embodiment of the present invention.

The flow chart of FIG. 7 only represents one possible scenario among others. The order of steps shown in FIG. 7 is not absolutely required, so generally, the various steps can be performed out of order. In a method according to the first embodiment of the present invention, in a first step 60, a signal (e.g., with DSR or MDSR) interfering according to a predetermined rule with at least one further signal is identified by the network (e.g., a network element such as BTS, BSS or Node B, etc.) and/or by the mobile station, wherein the bandwidths in a frequency domain of the signal and of the at least one further signal overlap.

In a next step 62, it is ascertained whether the bandwidth overlapping is larger than a predetermined amount. If that is not the case, the process goes back to the step 60 to continue the process of identification of the interference. However, if it is determined that the bandwidth overlapping is larger than the predetermined amount, in a next step 64, the carrier frequency of the signal is shifted by a frequency shift using a predetermined criterion for eliminating or reducing the interference.

It is further noted that, according to an embodiment of the present invention, signalling of single frequency offset for the DSR or MDSR (e.g., see signal 52a in FIG. 5) may be implemented in a straightforward fashion, e.g., by one bit among frequency parameters, but if that needs to be done dynamically or based on the actual frequency, other methods may be applied, for example using a bit map or a frequency list. Furthermore, in case of multi-slot configurations, the mobile station may need to hop between time slots to have or not have the frequency offset.

As explained above, the invention provides both a method and corresponding equipment consisting of various modules providing the functionality for performing the steps of the method. The modules may be implemented as hardware, or may be implemented as software or firmware for execution by a computer processor. In particular, in the case of firmware or software, the invention can be provided as a computer program product including a computer readable storage structure embodying computer program code (i.e., the software or firmware) thereon for execution by the computer processor.

It is noted that various embodiments of the present invention recited herein can be used separately, combined or selectively combined for specific applications.

It is to be understood that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

What is claimed is:

1. A method, comprising:
identifying a signal and at least one further signal in a service based mobile communication system, wherein bandwidths in a frequency domain of the signal and of the at least one further signal overlap; and
determining a frequency shift for shifting a carrier frequency of said signal according to a predetermined criterion.

2. The method of claim 1, wherein said determining the frequency shift for said signal according to the predetermined criterion is performed using at least one of:
a bandwidth of the signal,
a bandwidth of the at least one further signal,
the carrier frequency of the signal, and
a degree of said overlap of said bandwidths.

3. The method of claim 1, wherein said determining the frequency shift for said signal according to the predetermined criterion comprises:
identifying that said signal is interfering with said at least one further signal according to a predetermined rule, and
selecting the frequency shifting, if said overlapping of said bandwidths of said interfering signals is larger than a pre-selected amount.

4. The method of claim 1, wherein said frequency shift is a fixed offset.

5. The method of claim 1, wherein said signal has a dual symbol rate of 13/24 MHz with said bandwidth at half power substantially equals 541 kHz, said signal has a modified dual symbol rate of 13/32 MHz with said bandwidth at half power substantially equals 405 kHz, or said signal has a rate of 13/48 or 13/40 MHz with said bandwidth at half power substantially equals 325 kHz.

6. The method of claim 1, wherein said frequency shift is at least one of:
plus or minus 200 kHz, and
plus or minus 100 kHz.

7. The method of claim 1, wherein said signal and said at least one further signal are for a communication between a mobile station and a network element in said mobile communication system.

8. The method of claim 7, wherein said signal and said at least one further signal are for an uplink communication from a mobile station to a network element.

9. The method of claim 7, wherein said communication between the mobile station and the network element is performed within an evolved global system for mobile communications/enhanced data rates for global evolution radio access network.

10. The method of claim 7, wherein said identifying or said determining is performed by at least one of:
the network element, and
the mobile station.

11. The method of claim 7, wherein said identifying and said determining is performed by the network element and said signal is received by said network element from the mobile station, and the method further comprises:
providing an instruction signal comprising said frequency shift by said network element to said mobile station for shifting the carrier frequency of said signal.

12. The method of claim 7, wherein said identifying and said determining is performed by the mobile station and said signal is provided by the mobile station to the network element, and the method further comprises:
shifting by said mobile station a carrier frequency of said signal by said frequency shift.

13. The method of claim 1, wherein said at least one further signal is at least one out of:
a speech signal,
a data signal using an enhanced general packet radio service, and
a data signal using a dual symbol rate or a modified dual symbol rate.

14. The method of claim 1, wherein said service based mobile communication system is configured to be for at least one of the following services:
a dual symbol rate service,
a modified symbol rate service, and
an enhanced general packet radio service.

15. The method of claim 1, wherein said shifting the carrier frequency is for avoiding or minimizing overlapping of said bandwidths.

16. A computer program product comprising: a computer readable storage structure embodying computer program code thereon for execution by a computer processor with said computer program code, wherein said computer program code comprises instructions for performing the method of claim 1, indicated as being performed by any component or a combination of components of said mobile communication system.

17. A method, comprising:
generating an uplink signal by a mobile station of a mobile communication system, wherein a carrier frequency of said signal is shifted by a frequency shift; and
transmitting said signal by said mobile station to a network element,
wherein said signal and at least one further signal in said mobile communication system are identified, wherein bandwidths in a frequency domain of the signal and of the at least one further signal overlap before shifting said carrier frequency of the signal by the frequency shift, and said frequency shift is determined using a predetermined criterion.

18. The method of claim 17, wherein said network element is a base transceiver station, and the mobile station is a wireless communication device, a portable device, a mobile communication device, a mobile phone or a mobile camera phone.

19. A mobile communication system, comprising:
a frequency shift determining block configured to identify a signal and at least one further signal in said mobile communication system, wherein bandwidths in a frequency domain of the signal and of the at least one further signal overlap, and further to determine a frequency shift for said signal according to a predetermined criterion;
a signal generating block configured to shift a carrier frequency of said signal by the frequency shift;
a transmitter configured to transmit said signal with the frequency shift; and
a receiver configured to receive said signal with the frequency shift.

20. The mobile communication system of claim 19, wherein a network element of said mobile communication system comprises said frequency shift determining block and said receiver, and a mobile station of mobile communication system comprises said signal generating block and the transmitter.

21. A mobile station of a mobile communication system, comprising:
an uplink scheduling and signal generating module configured to generate an uplink signal, wherein a carrier frequency of said signal is shifted by a frequency shift; and
a module configured to transmit said signal to a network element, wherein said signal and at least one further signal in said mobile communication system are identified, wherein bandwidths in a frequency domain of the signal and of the at least one further signal overlap before shifting said carrier frequency of the signal by the frequency shift, and said frequency shift is determined using a predetermined criterion.

22. The mobile station of claim 21, wherein the uplink scheduling and signal generating module is further configured to determine the frequency shift for said signal according to the predetermined criterion using at least one of:
a bandwidth of the signal,
a bandwidth of the at least one further signal,
the carrier frequency of the signal, and
a degree of said overlap of said bandwidths.

23. The mobile station of claim 21, wherein the uplink scheduling and signal generating module is further configured to determine the frequency shift for said signal according to the predetermined criterion by:
identifying that said signal is interfering with said at least one further signal according to a predetermined rule, and
selecting the frequency shifting, if said overlapping of said bandwidths of said interfering signals is larger than a pre-selected amount.

24. The mobile station of claim 21, wherein said frequency shift is a fixed offset.

25. The mobile station of claim 21, wherein said signal has a dual symbol rate of 13/24 MHz with said bandwidth at half power substantially equals 541 kHz, said signal has a modified dual symbol rate of 13/32 MHz with said bandwidth at half power substantially equals 405 kHz, or said signal has a rate of 13/48 or 13/40 MHz with said bandwidth at half power substantially equals 325 kHz.

26. The mobile station of claim 21, wherein said frequency shift is at least one of:
plus or minus 200 kHz, and plus or minus 100 kHz.

27. The mobile station of claim 21, wherein said at least one further signal is at least one out of:
a speech signal,
a data signal using an enhanced general packet radio service, and
a data signal using a dual symbol rate or a modified dual symbol rate.

28. A network element of a mobile communication system, comprising:
a frequency shift determining and scheduling block configured to identify a signal and at least one further signal in said mobile communication system, wherein bandwidths in a frequency domain of the signal and of the at least one further signal overlap, and further configured to determine a frequency shift of the signal using a predetermined criterion, and still further configured to provide an instruction to a mobile station to shift a carrier frequency of said signal by the frequency shift; and
a receiver configured to receive said signal with the frequency shift from the mobile station.

29. The network element of claim 28, wherein the frequency shift determining and scheduling block is configured to determine the frequency shift for said signal according to the predetermined criterion using at least one of:
a bandwidth of the signal,
a bandwidth of the at least one further signal,
the carrier frequency of the signal, and
a degree of said overlap of said bandwidths.

30. The network element of claim 28, wherein the frequency shift determining and scheduling block is configured to determine the frequency shift for said signal according to the predetermined criterion by:
identifying that said signal is interfering with said at least one further signal according to a predetermined rule, and
selecting the frequency shifting, if said overlapping of said bandwidths of said interfering signals is larger than a pre-selected amount.

31. The network element of claim 28, wherein said signal has a dual symbol rate of 13/24 MHz with said bandwidth at half power substantially equals 541 kHz, said signal has a modified dual symbol rate of 13/32 MHz with said bandwidth at half power substantially equals 405 kHz, or said signal has a rate of 13/48 or 13/40 MHz with said bandwidth at half power substantially equals 325 kHz.

32. The network element of claim 28, wherein said frequency shift is at least one of:
plus or minus 200 kHz, and
plus or minus 100 kHz.

33. The network element of claim 28, wherein said at least one further signal is at least one out of:
a speech signal,
a data signal using an enhanced general packet radio service, and
a data signal using a dual symbol rate or a modified dual symbol rate.
